(19) United States
(12) Patent Application Publication
(10) Pub. No.: US 2015/0093812 A1
(43) Pub. Date: Apr. 2, 2015

(54) BIOARTIFICIAL FILTRATION ORGAN

(71) Applicant: The General Hospital Corporation, Boston, MA (US)

(72) Inventor: Harald C. OTT, Wenham, MA (US)

(21) Appl. No.: 14/395,297

(22) PCT Filed: Mar. 15, 2013
(86) PCT No.: PCT/US13/31874

§ 371 Date: Oct. 17, 2014

Related U.S. Application Data
(60) Provisional application No. 61/635,043, filed on Apr. 18, 2012.

(51) Int. Cl. A01N 1/02

(52) U.S. Cl. CPC A01N 1/0247
USPC 435/284.1

(57) ABSTRACT

A bioartificial filtration organ can be produced from an organ scaffold by re-seeding the scaffold with endothelial cells or cell progenitors and with epithelial cells or cell progenitors in a negative pressure environment. The negative pressure encourages the re-seeding over a greater extent of the scaffold.

### CROSS-REFERENCE TO RELATED APPLICATIONS

This application claims benefit under 35 U.S.C. §119(e) of U.S. Provisional Application No. 61/635,043, filed Apr. 18, 2012, the contents of which are incorporated herein by reference in its entirety.

### GOVERNMENT SUPPORT

This invention was made with US Government support under contract DP2 OD008749-01 awarded by the US National Institutes of Health. The US Government has certain rights in this invention.

### BACKGROUND

1. Technical Field of the Invention

The present invention is directed to a bioartificial filtration organ and methods and systems for making such organ. More specifically, the present invention is directed to bioartificial filtration organs, such as kidney and liver type organs and methods for producing the same.

2. Description of the Prior Art

Nearly one million patients in the US live with end stage renal disease (ESRD) with over 100,000 new diagnoses every year ((CDC), C.f.D.C.a.P. National chronic kidney disease fact sheet: general information and national estimates on chronic kidney disease in the United States, 2010. (U.S. Department of Health and Human Services (HHS), CDC, Atlanta, Ga., 2010)). Although hemodialysis has increased survivorship of those with end-stage renal disease (ESRD), transplantation remains the only available curative treatment. About 18,000 kidney transplants are performed per year in the United States1, yet nearly 100,000 Americans currently await a donor kidney (OPTN: Organ Procurement and Transplantation Network Website. Vol. 2012). Escalating patient demands are met with stagnant donor organ numbers, bringing the average waiting time over three years and the waitlist mortality to 5-10% depending on diagnosis. Despite advances in renal transplant immunology (Kawai, T., et al. HLA-mismatched renal transplantation without maintenance immunosuppression. N Engl J Med 358, 353-361 (2008)), 20% of recipients will experience an episode of acute rejection within five years of transplantation, and approximately 40% of transplanted (deceased-donor grafts) individuals will die or loose graft function within ten years after transplantation. Creation of an autologous bioengineered kidney could theoretically bypass these problems by providing a graft on demand to avoid the need for long-term hemodialysis in ESRD.

The kidney performs filtration, secretion, absorption, and synthetic functions to maintain a homeostatic fluid and electrolyte balance, and clears metabolites and toxins. Hemofiltration and hemodialysis use an acellular semipermeable membrane to substitute some but not all of these functions. Several attempts have been made to bioengineer viable tubular structures to supplement hemofiltration with cell dependent functions (Humes, H. D., Krauss, J. C., Cieslinski, D. A. & Funke, A. J. Tubulogenesis from isolated single cells of adult mammalian kidney: clonal analysis with a recombinant retrovirus. The American journal of physiology 271, F42-49 (1996); Humes, H. D., MacKay, S. M., Funke, A. J. & Buffington, D. A. Tissue engineering of a bioartificial renal tubule assist device: in vitro transport and metabolic characteristics. Kidney international 55, 2502-2514 (1999)) When hemofiltration devices were combined with bioengineered renal tubules, the resulting bioartificial kidney (BAK) replaced renal function in uremic dogs (Humes, H. D., Buffington, D. A., MacKay, S. M., Funke, A. J. & Weitzel, W. F. Replacement of renal function in uremic animals with a tissue-engineered kidney. Nat Biotechnol 17, 451-455 (1999)) and temporarily improved renal function in patients with acute renal failure (Humes, H. D., et al. Initial clinical results of the bioartificial kidney containing human cells in ICU patients with acute renal failure. Kidney international 66, 1578-1588 (2004); Humes, H. D., Weitzel, W. F. & Fissell, W. H. Renal cell therapy in the treatment of patients with acute and chronic renal failure. Blood Purif 22, 60-72 (2004)). In an alternative approach, kidney primordia have been shown to develop into a functional organ in vivo and prolong life when transplanted into anephric rats (Rogers, S. A. & Hammerman, M. R. Prolongation of life in anephric rats following de novo renal organogenesis. Organogenesis 1, 22-25 (2004)). Devices to make renal assist devices more portable (Gura, V., Macy, A. S., Beizai, M., Ezon, C. & Golper, T. A. Technical breakthroughs in the wearable artificial kidney (WAK). Clin J Am Soc Nephrol 4, 1441-1448 (2009)) or even implantable (Fissell, W. H. & Roy, S. The implantable artificial kidney. Semin Dial 22, 665-670 (2009)) have reached the stage of preclinical evaluation and hold tremendous promise to improve the quality of life of patients in end stage renal failure. One key step to develop a fully implantable, permanent graft is the development of a scaffold material that facilitates filtration and reabsorption, supports regeneration of functional tissue from seeded cells, and allows full recipient integration via blood perfusion.

### SUMMARY

The present invention is directed to methods and systems for producing bioartificial filtration organs, for example, a kidney or liver. In accordance with the invention, cadaveric whole organ were decellularized to produce an extracellular matrix (ECM) scaffold. The ECM scaffold can be repopulated by seeding with endothelial and epithelial cells. In accordance with the invention, seeding can be accomplished by perfusion of endothelial cells, for example, human umbilical venous endothelial cells (HUVEC) via the renal artery and instillation of suspended neonatal kidney cells (NKC) via the ureter. In accordance with some embodiments, the cell delivery can be performed in a seeding chamber that provides for controlled pressure and temperature of the ECM scaffold during seeding. In accordance with some embodiments of the invention, the ECM scaffold was subject to an ambient vacuum in the range between 0 and 80 cm H₂O in order to create a transrenal pressure gradient over the scaffold. The seeding step can be performed until the kidney constructs become stabilized and then the organ can be transferred to a perfusion bioreactor to provide whole organ culture conditions to culture the organ to the next level of maturity.

In accordance with some embodiments of the invention, the decellularized whole organ can be seeded in a seeding system. The seeding system can include a first chamber that can be adapted to support or suspend the ECM scaffold above the bottom surface of the first chamber and provide a controlled pressure and/or temperature for cell seeding of the ECM scaffold. A vacuum pump and pressure sensor can be provided to enable ambient pressure within the first chamber to be controlled, for example, using a dedicated controller or a programmed computer.

The renal artery of the ECM scaffold can be connected to a cell reservoir configured to contain an arterial endothelial cell suspension that can be pumped under controlled pressure into the renal artery. A pressure sensor can be coupled to the tube that feeds the arterial endothelial cells into the renal artery and the sensor output can be connected to the controller or a programmed computer that controls the operation of the pump to control the pressure into the renal artery. The ureter of the ECM scaffold can be connected to a cell reservoir configured to contain an epithelial cell suspension that can be pumped under controlled pressure into the ureter. A pressure sensor can be coupled to the tube that feeds the epithelial cells into the ureter and the sensor output can be connected to the controller or a programmed computer that controls the operation of the pump to control the pressure into the ureter. The renal vein of the ECM scaffold can be connected to a cell reservoir configured to contain a venous endothelial cell suspension that can be pumped under controlled pressure into the renal vein. A pressure sensor can be coupled to the tube that feeds the venous endothelial cells into the renal vein and the sensor output can be connected to the controller or a programmed computer that controls the operation of the pump to control the pressure into the renal vein.

The first chamber, the arterial endothelial cell suspension, the epithelial cell suspension, and the venous endothelial cell suspension can also be maintained in a temperature controlled environment. In accordance with some embodiments, the first chamber, the arterial endothelial cell suspension, the epithelial cell suspension, and the venous endothelial cell suspension can be contained within a second chamber that includes a heating element and temperature sensor connected to the controller or programmed computer. The temperature sensor allows the controller or programmed computer to monitor the temperature of cell seeding environment and control the heating element to control the cell seeding environment temperature.

In accordance with other embodiments of the invention, the bioartificial kidney can be formed using a decellularized lung scaffold. In accordance with other embodiments of the invention, a bioartificial liver can be formed using a decellularized lung scaffold.

In accordance with other embodiments of the invention, an artificial ECM scaffold can be formed that, after seeding, produces a bioengineered kidney that provides for counter-current filtration between the vascular space and urinary space. In this embodiment, the vascular structures are formed in a predefined configuration that provides for flow in a first direction and the urinary vessels provide for counter-current flow in the opposite direction to induce solute and water transfer from the blood vessels to the urinary vessels.

In accordance with implementations of the invention, one or more of the following capabilities can be provided. In some embodiments, method of making a bioartificial filtration whole organ based on the introduction of two or more cell types to a decellurarized matrix is provided. The method can comprise the application of a vacuum pressure gradient over the decellularized organ scaffold to promote efficient ingress of epithelial cells to a blind-ended biofiltration compartment. Similarly, a bioartificial filtration whole organ produced by the introduction of two or more cell types to a decellurarized matrix is provided. The cell types will include at least one endothelial cell type or progenitor that re-seeds and re-constitutes functional vascular spaces of the organ, and at least one epithelial cell type or progenitor thereof that re-seeds and re-constitutes a functional epithelial biofiltration compartment that interfaces with the blood supply as the blood transits the vascular space. In some embodiments, the invention provides for enabling filtration and reabsorption in a biortificial construct. In some embodiments, a bioartificial kidney in obtained. In some embodiments, a bioartificial liver is obtained. In some embodiments a system for the preparation of bioartificial organs that perform one or more biofiltration functions is provided.

These and other capabilities of the invention, along with the invention itself, will be more fully understood after a review of the following figures, detailed description, and claims.

### BRIEF DESCRIPTION OF THE FIGURES

FIG. 1 shows a diagrammatic view of a cell seeding system according to some embodiments of the invention.

FIGS. 2A and 2B show diagrammatic views of a bioengineered kidney derived from a decellularized lung scaffold according to some embodiments of the invention.

FIGS. 3A and 3B show diagrammatic views of a bioengineered liver derived from a decellularized lung scaffold according to some embodiments of the invention.

FIG. 4 illustrates the perfusion decellularization of whole rat kidneys. (a) Time lapse photographs of a cadaveric rat kidney, undergoing antegrade renal arterial perfusion decellularization. Ra, renal artery; Rv, renal vein; U, ureter. A freshly isolated kidney (left); after 6 hours of SDS perfusion (middle); after 12 hours of SDS perfusion (right). (b) Representative corresponding Movat's Pentachrome stained sections of rat kidney during perfusion decellularization (black arrowheads showing Bowman's capsule, scale bar 250 μm). (c) Representative immunohistochemical stains of cadaveric rat kidney sections showing distribution of elastin (black arrowheads pointing at elastic fibers in tunica media of cortical vessels), collagen IV and laminin (black arrowheads highlighting glomerular basement membranes) (scale-bars 250 μm, inserts 40×). (d) Corresponding sections of decellularized rat kidney tissue after immunohistochemical staining for elastin, collagen IV and laminin confirming preservation of extracellular matrix proteins in the absence of cells (scale-bars 250 μm, inserts 40×). (e) Transmission electron micrograph (TEM) of a cadaveric rat glomerulus showing capillaries (C), mesangial matrix (M) and podocytes (P) surrounded by Bowman's capsule (BC) (scale bar 10 μm). (f) TEM of decellularized rat glomerulus exhibiting acellularity in decellularized kidneys with preserved capillaries (C), mesangial matrix (M) and Bowman's space encapsulated by Bowman's capsule (BC) (scale bar 10 μm). (g-i) Biochemical quantification of DNA, total collagen, and sulfated glycosaminoglycans in cadaveric and decellularized rat kidney tissue (average±SD, p-value determined by student's t-test) show reduction of DNA content and preservation of collagen and glygosaminoglycans after perfusion decellularization (ns: non significant). (j) Morphometric analysis of histologic cross sections of cadaveric and decellularized rat kidneys. Decellularized kidneys contract with dehydration and embedding leading to an apparent increase in number of glomeruli per mm², a decrease in glomerular diameter and Bowman's space. The total count of glomeruli per cross section remained unchanged after decellularization.

FIG. 5 illustrates the cell seeding and whole organ culture of decellularized rat kidneys. (a) Schematic of a cell seeding apparatus enabling endothelial cell seeding via port A attached to the renal artery (ra), and epithelial cell seeding via port B attached to the ureter (u), while negative pressure in the organ chamber is applied to port C thereby generating a transrenal pressure gradient. (b) Schematic of a whole organ culture in a bioreactor enabling tissue perfusion via port A attached to the renal artery (ra) and drainage to a reservoir via port B (u: ureter, k: kidney). (c) Cell seeded decellularized rat kidney in whole organ culture. (d) Fluorescence micrographs of a re-endothelialized kidney constructs. CD31 (red) and DAPI-positive HUVECs line the vascular tree across the entire graft cross section (image reconstruction, left, scale bar 500 μm) and form a monolayer to glomerular capillaries (right panel, white arrowheads point to endothelial cells, scale bar 50 μm). (e) Fluorescence micrographs of re-endothelialized and re-epithelialized kidney constructs showing engraftment of podocin (green) expressing cells and endothelial cells (CD31 positive, red) in a glomerulus (left panel, scale bar 25 μm, white arrowheads mark Bowman's capsule, white star marks vascular pole); engraftment of Na/K ATPase expressing cells (green) in basolateral distribution in tubuli resembling proximal tubular structures with appropriate nuclear polarity (left middle panel, scale bar 10 μm, T tubule, Ptc peritubular capillary); engraftment of E-cadherin expressing cells in tubuli resembling distal tubular structures (right middle panel, scale bar 10 μm, T tubule, Ptc peritubular capillary); 3D reconstruction of a reendothlialzied vessel leading into a glomerulus (white arrowheads mark Bowman's capsule, white star marks vascular pole). (f) Image reconstruction of an entire graft cross section confirming engraftment of podocin expressing epithelial cells (scale bar 500 μm). Image inserts show site-specific (right upper insert) and non-specific (lower insert) cell engraftment. Representative immunohistochemical stains of rat cadaveric kidney sections showing podocin expression in a glomerulus (middle panel, scale bar 50 μm). (g) Immunohistochemcial stain for podocin of a rat cadaveric glomerulus (scale bar 50 μm). (h) Nephrin expression in regenerated glomeruli (left panel) and cadaveric control (right panel, scale bar 50 μm). (i) Aquaporin-1 expression in regenerated proximal tubular structures (left panel) and cadaveric control (right panel, scale bar 50 μm). (j) Na/K ATPase expression in regenerated proximal tubular epithelium (left panel) and cadaveric control (right panel, scale bar 50 μm). (k) E-Cadherin expression in regenerated distal tubular epithelium (left panel), and cadaveric control (right panel, scale bars 50 μm). (l) Representative immunohistochemical stains of bioengineered kidney construct sections showing beta-1 integrin expression in a glomerulus (left panel). (m) Representative transmission electron micrograph of a regenerated glomerulus showing a capillary with red blood cells (RBC), and foot processes along the glomerular basement membrane (black arrowheads)(left panel, scale bar 2 μm), transmission electron micrograph of a podocyte (P) adherent to the glomerular basement membrane (black arrowheads)(right panel, scale bar 2 μm, BC Bowman's Capsule). (n) Scanning electron micrograph of a glomerulus (white arrowheads) in a regenerated kidney graft cross section (vascular pedicle *, scale bar 10 μm). (o) Morphometric analysis of histologic cross sections of cadaveric and regenerated rat kidneys. Glomeruli per cross section, average glomerular diameter, and Bowman's space remain unchanged in regenerated kidneys. Glomerular capillary lumen appeared to be smaller in regenerated kidneys compared to cadaveric kidneys due to increased number of HUVECs in regenerated constructs compared to the number of cadaveric glomerular capillary endothelial cells.

FIG. 6 illustrates in vitro function of bioengineered kidney constructs. (a) Photograph of a bioengineered rat kidney construct undergoing in vitro testing. The kidney is perfused via the canulated renal artery (Ra), and renal vein (Rv), while urine is drained via the ureter (U). The white arrowhead marks the urine/air interface in the drainage tubing. (b) Bar graph summarizing average urine flow rate (mL/min) for decellularized, cadaveric, and regenerated kidneys perfused at 80 mmHg and regenerated kidneys perfused at 120 mmHg (regenerated*). Decelularized kidneys showed a polyuric state while regenerated constructs were relateively oliguric compared to cadaveric kidneys. (c) Bar graph showing average creatinine clearance in cadaveric, decellularized and regenerated kidneys perfused at 80 mmHg and regenerated kidneys perfused at 120 mmHg (regenerated*). With increased perfusion pressure creatinine clearance in regenerated kidneys improved. (d) Urinalysis of isolated cadaveric (yellow), decellularized (blue), and regenerated (orange) kidney constructs. Significant differences between groups are listed as *p<0.05, **p<0.01, ***p<0.001 after 1-way ANOVA with Bonferroni post hoc correction. Fractional retention (R), reabsorption (r), and excretion (e) of solutes are expressed as percentages of the calculated filtered amount. (e) Bar graph showing vascular resistance of cadaveric decellularized and regenerated kidneys showing an increase in vascular resistance with decellularization and partial recovery in regenerated kidneys. (f) Schematic model of cadaveric, decellularized, and regenerated kidney function based on histology and results of in vitro functional testing.

FIG. 7 illustrates orthotopic transplantation and in vivo function. (a) Photograph of rat peritoneum after laparotomy, left nephrectomy, and orthotopic transplantation of a regenerated left kidney construct. Recipient left renal artery (Ra) and left renal vein (Rv) are connected to the regenerated kidney's renal artery and vein. The regenerated kidney's ureter (U) remained cannulated for collection of urine production post implantation. (b) Photograph of the transplanted regenerated kidney construct after unclamping of left renal artery (Ra) and renal vein (Rv) showing homogeneous perfusion of the graft without signs of bleeding. (c) Composite histologic image of a transplanted regenerated kidney confirming perfusion across the entire kidney cross section (scale bar 500 μm). (d) Higher magnification of a regenerated kidney section showing erythrocytes in blood vessels leading up to a glomerulus in the absence of interstitial bleeding.

FIG. 8 illustrates trypan blue perfusion of perfusion decellularized rat kidneys. On the photograph of a decellularized kidney perfused with trypan blue through the renal artery, the segmental, interlobar, arcuate, and interlobular arteries are highlighted indicating preserved vascular conduits after perfusion decellularization.

### DETAILED DESCRIPTION OF PREFERRED EMBODIMENTS

The present invention is directed to methods and system for producing bioartificial filtration organs, for example, a kidney or liver. In accordance with the invention, cadaveric kidneys and lungs were decellularized to produce an extracellular matrix (ECM) scaffold of the whole organ. The ECM scaffold can be repopulated by seeding the scaffold with endothelial and epithelial cells. In accordance with the invention, seeding can be performed in a temperature and/or pressure controlled environment.

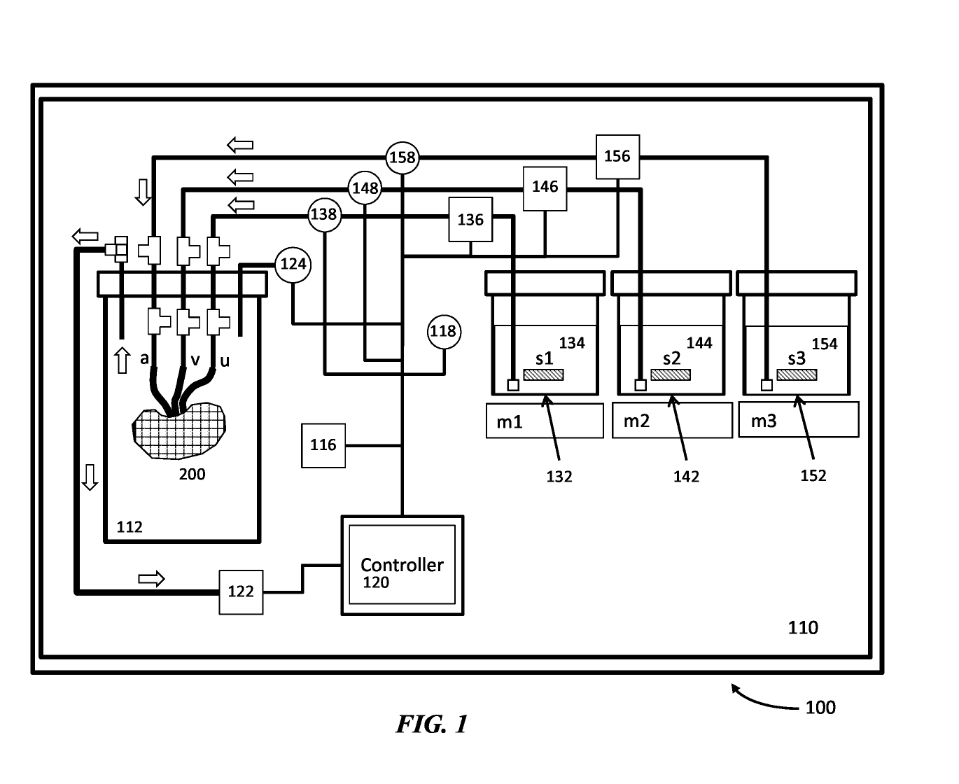

FIG. 1 shows a diagrammatic view of a cell seeding system 100 according to some embodiments of the invention. The cell seeding system 100 can include a seeding chamber 112 which can be of sufficient size to enclose a whole filtration organ scaffold 200 to be seeded and provide a controlled pressure environment. The seeding chamber 112 can include a plurality of ports that enable the fluids (e.g., gas and liquid) to be pumped into and out of the seeding chamber 112. The scaffold 200 can include a plurality of vessels, including a renal artery a, a renal vein v and ureter u which can be used to perfuse cells into the scaffold 200.

The seeding chamber 112 can include a pressure control system that includes a vacuum pump 122 and pressure sensor 124 that can be coupled to a controller 160. The controller 160 can control the vacuum pump 122 in response to signals from the pressure sensor 124 indicating the pressure inside the seeding chamber 112 to control the pressure inside the seeding chamber 112. The vacuum pump 122 can be connected to tubing that passes through one of the ports in the seeding chamber 112. The controller 160 can be dedicated pressure controller that is adapted and configured to control the vacuum pump 122 to maintain the pressure in the seeding chamber 112 at a set level. Alternatively, the controller 160 can be a programmed computer that controls the pressure at a set level or according to program that can change the pressure over time. In accordance with some embodiments of the invention, the pressure control system can maintain the pressure in the seeding chamber 112 in a range from 0 cm to 80 cm of H₂O. In accordance with some embodiments of the invention, the pressure control system can maintain the pressure in the seeding chamber 112 in a range from 10 cm to 70 cm of H₂O. In accordance with some embodiments of the invention, the pressure control system can maintain the pressure in the seeding chamber 112 in a range from 20 cm to 60 cm of H₂O. In accordance with some embodiments of the invention, the pressure control system can maintain the pressure in the seeding chamber 112 above 80 cm of H₂O. The pressure maintained in the seeding chamber can determined as a function of the scaffold porosity and the nature of the cells to be seeded. In accordance with some embodiments, the pressure can be determined empirically based on the quantity of cells to be seeded in the scaffold.

The scaffold can be connected to one or more reservoirs that provide cells for seeding. As shown in FIG. 1, a separate reservoir can be provided for each vessel a, v, u that allows provides a flow path into the scaffold 200. Wherein the scaffold 200 is a kidney, the ureter u flow path can be connected by a tube to a reservoir 132 that contains an epithelial cell suspension 134. A pump 136, connected to controller 160, can be used to pump the epithelia cell suspension 134 into the ureter u at a predefined pressure. A pressure sensor 138, connected to controller 160, can be connected to the tube to monitor the pressure of the epithelial cell suspension 134 that is pumped into the scaffold 200. The arterial vessel a of the scaffold 200 can be connected by a tube to a reservoir 142 that contains an arterial endothelial cell suspension 144. A pump 146, connected to controller 160, can be used to pump the arterial endothelia cell suspension 144 into the artery a at a predefined pressure. A pressure sensor 148, connected to controller 160, can be connected to the tube to monitor the pressure of the arterial endothelial cell suspension 144 that is pumped into the scaffold 200. The venous vessel v of the scaffold 200 can be connected by a tube to a reservoir 152 that contains a venous endothelial cell suspension 154. A pump 156, connected to controller 160, can be used to pump the venous endothelia cell suspension 154 into the vein v at a predefined pressure. A pressure sensor 158, connected to controller 160, can be connected to the tube to monitor the pressure of the venous endothelial cell suspension 154 that is pumped into the scaffold 200. Each of the reservoirs 132, 142, 152 can include a mixing component, such as a magnetic mixer m1, m2, m3 and a stir bar s1, s2, s3 to maintain the suspensions.

In accordance with some embodiments of the invention, the quantity of cells to be seeded will depend on the size and the nature of the organ. In accordance with some embodiments of the invention, the scaffold 200 can be seeded with approximately 10 million to 100 million epithelial cells for each 1.0 to 1.5 grams of tissue of the scaffold 200, 10 million to 100 million arterial endothelial cells for each 1.0 to 1.5 grams of tissue of the scaffold 200, and 10 million to 100 million venous endothelial cells for each 1.0 to 1.5 grams of tissue of the scaffold 200. In accordance with some embodiments of the invention, the each reservoir can be filled with approximately 0.5 million to 5 million cells/cc of solution.

During the seeding process, the seeding chamber 112 can be maintained at a predefined temperature. In accordance with some embodiments, the seeding chamber 112 can be enclosed in a heating chamber 110 that can include a temperature sensor 118 and heating element 116 connected to a control mechanism that operates the heating element to maintain the temperature at a set level or range. In accordance with some embodiments of the invention, the temperature sensor 118 and the heating element 116 can be connected to the controller 120 that can control the heating element 116 in response to signals from the temperature sensor to control the temperature of the seeding chamber 112. In accordance with other embodiments of the invention, the heating chamber can also include the reservoirs 132, 142 and 152 in order to maintain the cell suspensions at the same temperature. In accordance with some embodiments, during the seeding process, the seeding chamber 112 can be maintained in a range from 20 to 40 degrees C.

In accordance with some embodiments of the invention, the scaffold 200 can be derived from a kidney or a lung or another filtration organ that provides an arterial connection, a venous connection and a third connection to separate pathway that provides for the filtration output in the filtration organ being created. In the kidney, the third connection corresponds to the ureter, and in the lung, the third connection corresponds to the trachea and air space. In the established organ, the arterial connection provides for blood inflow and the venous connection provides for blood outflow and within the organ a membrane or other structure provides for the transfer of at least one solute and water from the blood to the third connection. Thus, for example, a bioartificial kidney can be produced from a kidney scaffold or a lung scaffold. In another example, a bioartificial liver can be produced from a kidney scaffold or lung scaffold.

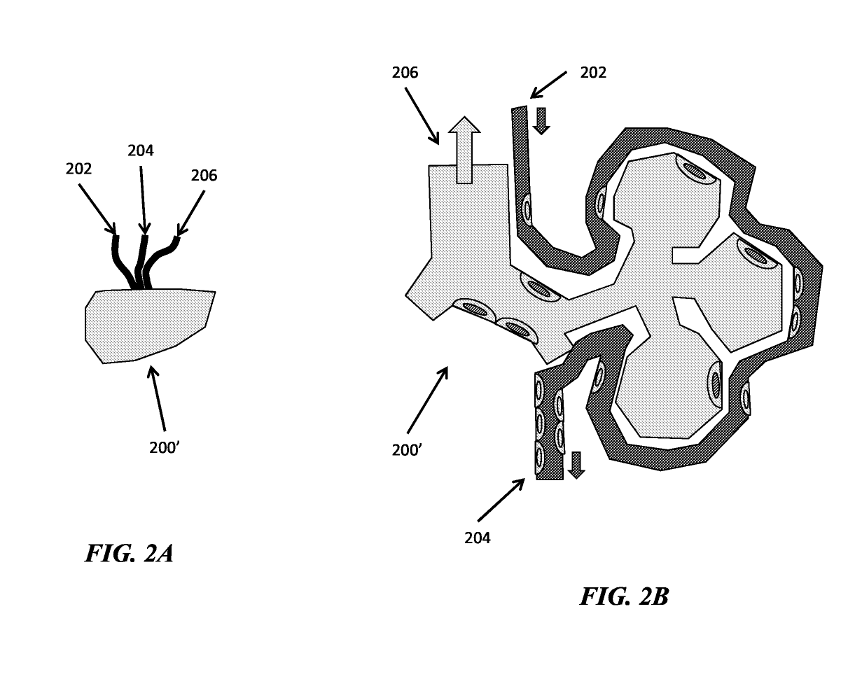

FIGS. 2A and 2B show diagrammatic views of a bioengineered kidney derived from a decellularized lung scaffold 200′. As shown in FIG. 2A, the lung scaffold 200′ includes an arterial connection 202, a venous connection 204 and a tracheal connection 206. The arterial connection 202 will become the renal artery by seeding it with arterial endothelial cells. The venous connection 204 will become the renal vein by seeding it with venous endothelial cells and the tracheal connection 206 will become the ureter by seeding it with epithelial cells. FIG. 2B shows a diagrammatic view of the blood flow into the renal artery 202 and out the renal vein 204 while urine drains from what was the airway of the lung, the trachea 206.

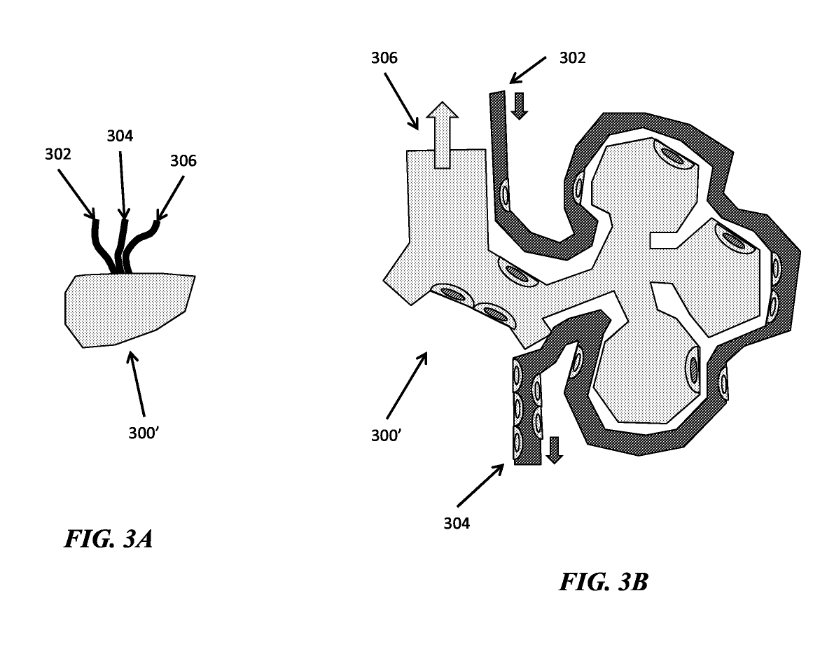

FIGS. 3A and 3B show diagrammatic views of a bioengineered liver derived from a decellularized lung scaffold. As shown in FIG. 3A, the scaffold includes an arterial connection, a venous connection and a tracheal (or bronchial) connection. The arterial connection will become the hepatic artery by seeding it with arterial endothelial cells. The venous connection will become the hepatic vein by seeding it with venous endothelial cells and the tracheal connection will become the hepatic duct by seeding it with epithelial cells or hepatocytes. FIG. 3B shows a diagrammatic view of the blood flow into the hepatic artery and out the hepatic vein while bile drains from what was the airway of the lung.

In accordance with some embodiments of the invention, the scaffolds can be 3-dimensional whole organ scaffolds that include at least one arterial vessel and one venous vessel for connecting the reseeded organ to a blood supply. Upon implantation the reseed organ can receive blood through the arterial vessel and return blood through the venous vessel. In accordance with some embodiments of the invention, the filtration organ can function, at least in part, to remove a filtrate from a blood supply flowing through connections to an arterial vessel and a venous vessel of the reseeded organ. In addition, the filtration organ can also include a compartment or space which receives the filtrate (e.g., urine or bile) and includes a efferent vessel the enables the organ to expel the filtrate by connection, for example, to the urinary tract or digestive tract of an animal. Examples of filtration organs include the kidney and the liver and efferent vessel of the kidney is the ureter and efferent vessel of the liver is hepatic duct. Where a lung scaffold is used and seeded with kidney or liver cells, the tracheal or bronchial passage will become the efferent vessel.

In accordance with some of the methods of the invention, filtration organ extracellular matrix (ECM) scaffolds with intact and perfusable vascular and tubular components can be created by decellularlizing cadaveric human and non-human organs, including for example, kidneys, lungs and similar organs. The ECM scaffolds can be examined to confirm that the ECM composition is intact and the microarchitecture is preserved. Some of the bioartificial organs according the invention can be created by repopulating the ECM scaffold with functional endothelial and epithelial cells. In accordance with some embodiments of the invention, the repopulation can be performed by reseeding the ECM scaffold in a seeding chamber such as shown in FIG. 1 and described herein. After reseeding, the seeded ECM scaffold can be cultured in an in vitro biomimetic culture via arterial perfusion in order to encourage the formation of functional renal tissue and associated renal functions, including filtration, reabsorption and urine production. Alternatively, the seeded ECM scaffold can be cultured in vivo by transplantation into a host, either replacing an existing organ or in addition thereto.

### Scaffold Decelluarization

Decellularization of kidney and lung tissue to generate extracellular matrix scaffold appropriate for re-seeding or re-cellularization with appropriate donor cells is described in the Examples herein, as well as, for example, in Mishra et al., 2012, Ann. Thorac. Surg. 93: 1075-1081 (lung decellularization), and Song et al, 2011, Ann. Thorac. Surg. 92: 998-1005 (lung decellularization). See also US 2009/0202977, which is incorporated herein by reference in its entirety and demonstrates decellularization of a number of different solid organs including heart, liver, lung and kidney.

### Cells for Scaffold Re-Cellularization:

Decelluarized scaffold, derived, e.g., from a donor kidney or donor lung as known in the art or as described herein, can be re-seeded with vascular endothelial cells or vascular endothelial cell progenitors to re-establish the vascular system of the decellaularized organ and with epithelial cells to re-establish a functional epithelium. If kidney epithelial cells are instilled, the resulting bioartificial organ can perform the kidney filtration function, with an output of urine. If, for example, liver epithelial cells are instilled, the bioartificial organ can perform the liver filtration function, with an output of bile. In either instance, cells for re-cellularization of a decelluarized scaffold can be, for example, derived from a donor organ or organs, or, alternatively, differentiated from stem cells, which can be, for example, embryonic stem cells, induced pluripotent stem cells or adult stem cells from either a heterologous donor source or autologous to the recipient.

In some embodiments, tissue scaffold, e.g., decellularized kidney or lung scaffolds can be seeded with populations of endothelial and epithelial cells as described herein that are then permitted to proliferate in situ to fully re-populate or re-generate the organ. That is, it is expected that in some embodiments there will be significant cell proliferation on the scaffold to establish the functional organ tissue. Such proliferation generally occurs when the seeded tissue scaffold is incubated in a bioreactor system as described herein, in which the vascular system is perfused with culture medium, for example, under substantially continuous flow. Cell proliferation can be stimulated by addition of appropriate growth factors to the medium if necessary. For example, endothelial cell proliferation can be stimulated by the addition of VEGF, and/or other growth factors and hormones as known in the art. Similar approaches can be applied to stimulate epithelial cell expansion using factors appropriate for the cell type involved. The preparation of various cells for re-cellularization is described in the following.

Vascular Endothelial Cells:

In some embodiments, human umbilical vein endothelial cells (HUVEC), isolated from human post-partum umbilical cord, can be used as a source of endothelial cell progenitors that can be expanded and used to seed the vasculature of the decellularized scaffold as described in the Examples herein below. The proper engraftment and function of these immature endothelial cells in the scaffolds described herein demonstrates that even relatively immature endothelial cells can be used, and that the scaffold extracellular matrix likely provides cues for the arrangement, attachment and further maturation of the cells to functioning arterial and venous vascular endothelium.

Alternatively, human endothelial cells can be derived from adult donor tissue. Methods for the isolation and large-scale expansion of human endothelial cells from adult tissue are described, for example, by Hofmann et al., 2009, J. Vis. Exp. 32: e1524, titled “Isolation and Large Scale Expansion of Adult Human Endothelial Colony Forming Progenitor Cells.” Briefly, the method described involves the use of heparinized, but otherwise unmanipulated human peripheral blood as a source of human endothelial colony-forming progenitors (ECFCs). The Hofmann et al. method is well suited to provide large numbers of human endothelial cell progenitors that have not been cultured in the presence of animal serum, and that form functional vascular structures when, for example, introduced subcutaneously in a mouse model.

As another alternative, embryonic stem (ES) cells induced to differentiate to a vascular endothelial cell or vascular endothelial cell progenitor phenotype can be used to repopulate the vascular space of the decelluarized scaffold. The differentiation of murine ES cells to a vascular endothelial cell phenotype is described, for example, by Darland et al., 2001, Curr. Top. Dev. Biol. 52: 107-149, and by Hirashime et al., 1999, Blood 93: 1253-1263, both of which are incorporated herein by reference in their entireties. The differentiation of a human ES cell line to a functional vascular endothelial cell phenotype is described, for example, by Levenberg et al., 2002, Proc. Natl. Acad. Sci. U.S.A. 99: 4391-4396. Briefly, the authors describe the preparation of embryoid bodies (EB) from cultured ES cells by removing the cells from their fibroblast feeder layer and culturing in suspension with culture medium lacking LIF and bFGF. After spontaneous differentiation within the embryoid bodies, dissociated EB cells were sorted via FACS using labeled anti-PECAM1 antibodies. The PECAM1 positive cell fraction was analyzed and found to be positive for additional endothelial cell markers, including vWF and the presence of N-cadherin and VE-cadherin cell junctions, and the cells took up acetylated-LDL. The endothelial cells thus isolated were demonstrated to generate functional vessel structures when transplanted into SCID mice. Human endothelial cells prepared from ES cells or an ES cell line in this manner or by any other manner known in the art provides a source of endothelial cells for seeding to a kidney or lung scaffold.

Another alternative source of endothelial cells for the re-cellularization of the scaffold's vasculature is cells differentiated from induced pluripotent stem (iPS) cells. iPS cells are pluripotent stem cells derived from differentiated cells, including adult differentiated cells, by “re-programming” the cells using expression of a panel of reprogramming protein factors. iPS cells have as one advantage the option to generate pluripotent stem cells from an individual to be treated with a bioartificial organ as described herein, thereby avoiding the need to provide a tissue type match with a donor tissue to avoid rejection. That is, iPS cells and cells differentiated from them are immunologically identical to the cells of the individual from whom they are obtained. iPS cells are easily expanded in culture and have the potential to be differentiated to essentially any cell or tissue type, thereby providing a source of large numbers of a desired type of cells. Induction of pluripotency was originally achieved by Yamanaka and colleagues using retroviral vectors to enforce expression of four transcription factors, KLF4, c-MYC, OCT4, and SOX2 (KMOS) (Takahashi, K. and S. Yamanaka, Cell, 2006. 126(4): p. 663-76; Takahashi, K., et al., Cell, 2007. 131(5): p. 861-72). Since that initial discovery, the methods for generating iPS cells have been refined and expanded upon to include non-retroviral expression of the factors and to include different combinations of reprogramming factors appropriate for varying cell types (Chang, C.-W., et al., Stem Cells, 2009. 27(5): p. 1042-1049; Kaji, K., et al., Nature, 2009. 458(7239): p. 771-5; Okita, K., et al., Science, 2008. 322(5903): p. 949-53; Stadtfeld, M., et al., Science, 2008. 322(5903): p. 945-9; Woltjen, K., et al., Nature, 2009; Yu, J., et al., Science, 2009: p. 1172482; Fusaki, N., et al., Proc Jpn Acad Ser B Phys Biol Sci, 2009. 85(8): p. 348-62).

Where implantation or transplantation of iPS cells or their differentiated progeny are considered, the development of non-retrovirally mediated or non-virally mediated reprogramming methods provides a safety advantage, in that the genome of the cell is not altered by viral insertion and the cell does not express any viral genes. Human pluripotent stem cells have been derived using nucleic acid-free methods, including serial protein transduction with recombinant proteins incorporating cell-penetrating peptide moieties (Kim, D., et al., Cell Stem Cell, 2009. 4(6): p. 472-476; Zhou, H., et al., Cell Stem Cell, 2009. 4(5): p. 381-4). A nucleic acid-based method that introduces modified RNA encoding the reprogramming factors has been recently described by Rossi and colleagues (see, e.g., US 2012/0046346). Because the introduced RNA does not modify the genome of the cell and is naturally degraded, the method is well suited for both generating iPS cells that will be used to prepare differentiated cells for transplant, as well as for subsequent introduction of protein factors that promote the differentiation of the iPS cells in the desired direction, e.g., to a vascular endothelial or kidney- or liver epithelial phenotype.

iPS cells can be differentiated to a vascular endothelial cell phenotype by methods known in the art. For example, Taura et al., Arteriosclerosis, Thrombosis and Vascular Biology 2009. 29: 1100-1103, titled “Induction and Isolation of Vascular Cells from Human Induced Pluripotent Stem Cells-Brief Report” describe a method of differentiating iPS cells to vascular endothelial cells. The authors demonstrated that the same method is applicable to human ES cell lines and results in endothelial cells with similar properties and efficiencies of production. Similarly, Choi et al., Stem Cells 2009. 27: 559-567, titled Hematopoietic and Endothelial Differentiation of Human Induced Pluripotent Stem Cells, describe the differentiation of human iPS cells and ES cell lines to CD31+, CD43-endothelial cells. Either or both of these approaches can be used to provide human endothelial cells or endothelial cell progenitors for use in re-seeding tissue scaffolds with vascular endothelial cells as necessary for the methods and compositions described herein.

Kidney Epithelial Cells:

Kidney epithelial cells can be isolated from donor kidney tissue or generated by differentiation of ES cells or iPS cells under the appropriate conditions.

Methods for isolating kidney epithelial cells from adult or, for example, neonatal tissue are described by Bussolati et al., Am. J. Pathol. 2005. 166: 545-555, titled Isolation of Renal Progenitor Cells from Adult Human Kidney. The cells isolated by the method described are CD133+ and express PAX-2, an embryonic renal cell marker, but lack expression of hematopoietic markers. CD133+ cells were isolated from the tubular fraction of adult kidney tissue by magnetic cell sorting, using the MACS system (Miltenyi Biotec, Auburn, Calif.). CD133⁺ cells were plated onto fibronectin in the presence of an expansion medium, consisting of 60% DMEM LG (Invitrogen, Paisley, UK), 40% MCDB-201, with 1× insulin-transferrin-selenium, 1× linoleic acid 2-phosphate, 10⁻⁹ mol/L dexamethasone, 10⁻⁴ ascorbic acid 2-phosphate, 100 U penicillin, 1000 U streptomycin, 10 ng/ml epidermal growth factor, and 10 ng/ml platelet-derived growth factor-BB (all from Sigma-Aldrich, St. Louis, Mo.) and 2% fetal calf serum (EuroClone, Wetherby, UK). For cell cloning, single cells were deposited in 96-well plates in the presence of the expansion medium. Epithelial differentiation was obtained in the presence of fibroblast growth factor-4 (10 ng/ml) and hepatocyte growth factor (20 ng/ml, Sigma). The cells can be expanded in culture and be differentiated in vitro to kidney epithelial and endothelial cell phenotypes. When implanted subcutaneously in SCID mice, the undifferentiated cells formed tubular structures expressing renal epithelial cell markers. The authors demonstrated that IV injection of the expanded CD133+ cells into SCID mice with glycerol-induced tubulonecrosis resulted in homing of the cells to the injured kidney and integration into tubules. As such, human donor kidney epithelial cell progenitors isolated in the manner described provide a source of donor kidney epithelial cells for the methods and compositions described herein.

Methods for differentiating human embryonic stem cells to kidney epithelial cells are known in the art and described, for example, by Narayanan et al., Kidney International. 2013. Feb. 6 Epub, titled “Human Embryonic Stem Cells Differentiate into Functional Renal Proximal Tubular-Like Cells.” The authors describe a protocol for the differentiation of human embryonic stem cells into renal epithelial cells in order to provide a reliable source of human renal cells. The cells differentiated according to their approach expressed markers characteristic of renal proximal tubular cells and their precursors, whereas markers of other renal cell types were not expressed or were expressed at low levels. Marker expression was similar to markers on primary cultured human renal proximal tubular cells, and the isolated cells formed tubular structures both in vitro and n vivoMarker expression patterns of these differentiated stem cells and in vitro cultivated primary human renal proximal tubular cells were comparable. The differentiated stem cells showed morphological and functional characteristics of renal proximal tubular cells, and generated tubular structures in vitro and in vivo. The cells generated in this manner can be used to re-seed kidney scaffold, or, alternatively, to seed, for example, the epithelial compartment of a lung scaffold as noted elsewhere herein.

Methods for differentiating human iPS cells to kidney epithelial cells are described, for example, by Song et al., 2012, PLOS One 7: e46453. Briefly, human iPS cell colonies were dissociated and cultured in suspension culture with DMEM-F12 and 2.5% Fetal Bovine Serum supplemented with Activin A, BMP-7 and retinoic acid. After 3 days, the cells were transferred to a 0.1% gelatin coated dish absent a feeder layer and cultured in monolayer for an additional 10 days, during which time the cells took on the morphology of cultured glomerular podocytes. The podocytes were then maintained in medium without Activin A, BMP-7 and retinoic acid supplementation, which permitted long-term proliferation in culture. The differentiated cells expressed podocin and synaptopodin with localization comparable to that in normal cultured human podocytes. The cells integrated into glomerular aggregates when re-aggregated with partially dissociated murine embryonic kidney explants. Kidney epithelial cells differentiated from iPS cells in this manner or in another manner known in the art can be used to re-populate kidney scaffolds as described herein.

It should be noted that when, for example, kidney scaffold is re-seeded with kidney epithelial cells, it is not by any means necessary that the cells be fully differentiated. In such instances, the scaffold ECM provides cues for progenitor cells or partially differentiated cells to complete their differentiation to the required epithelial cell type(s). The same is true for other decellularized tissue scaffolds. Thus, it can be an advantage in the methods described herein to apply immature or partially differentiated cells to the scaffolds described, and let the scaffold drive the appropriate differentiation. Thus, for example it is specifically contemplated that a tissue scaffold can be re-populated by seeding with stem cells, committed progenitor cells or fully differentiated cells. For example, a kidney scaffold is contemplated to be re-populated by seeding with mesodermal progenitors, kidney progenitors or fully or partially-differentiated kidney epithelial cells.

Hepatocytes:

Hepatocytes can also be prepared from donor tissue, differentiation from human ES cells or ES cell lines, or differentiation from iPS cells, including iPS cells derived from the intended recipient. Methods of isolating hepatocytes and hepatic epithelial cells from donor tissue (including tissue from living donors) are well known in the art. High efficiency generation of hepatocyte-like cells from human iPS cells is described, for example, by Si-Tayeb et al., 2010, Hepatology 51: 297-305. The cells exhibit key liver functions and can integrate into the hepatic parenchyma in vivo.

In accordance with some of the embodiments of the invention, the ECM scaffold, (e.g., a kidney or lung scaffold) can be suspended in the seeding chamber and connected to the reservoirs to enable perfusion of endothelial and epithelial cells. In accordance with some embodiments, the renal artery can be connected to a suspension reservoir for perfusion of endothelial cells, for example, suspended human umbilical venous endothelial cells (HUVEC). In accordance with some embodiments, the renal vein can be connected to a suspension reservoir for perfusion of endothelial cells, for example, suspended human umbilical venous endothelial cells (HUVEC). In accordance with some embodiments, the ureter can be connected to a suspension reservoir for perfusion of epithelial cells, for example, suspended neonatal kidney cells (NKC). Cell delivery and retention can be improved by the application of a vacuum in order to establish a pressure gradient across the scaffold when encourages the movement of the cells into the smaller spaces and to the full extent of the scaffold.

In accordance with some embodiments, the ECM scaffold can be subject to an ambient vacuum in the range between 0 and 80 cm H₂O in order to establish the desired transrenal pressure gradient. In accordance with other embodiments, and depending on the nature and size of the organ to be seeded, other vacuum pressure ranges can be used, for example, 10 to 70 cm H₂O, 20 to 60 cm H₂O, 30 to 50 cm H₂O, and greater than 80 cm H₂O. In accordance with some embodiments, the vacuum pressure can change over time, for example, starting at a high value, for example, 80 cm H₂O, to draw cells to furthest and deepest areas of the scaffold, and then decrease to, for example, 20 cm H₂O as the desired amount of cells is reached. In accordance with some embodiments, the vacuum pressure can change over time, for example, starting at a low value, for example, 20 cm H₂O, to draw cells into the scaffold, and then increase to, for example, 80 cm H₂O as the desired amount of cells is reached.

In accordance with some of the embodiments of the invention, the scaffold 200 can be seeded with approximately 10 million to 100 million epithelial cells for each 1.0 to 1.5 grams of tissue of the scaffold 200, 10 million to 100 million arterial endothelial cells for each 1.0 to 1.5 grams of tissue of the scaffold 200, and 10 million to 100 million venous endothelial cells for each 1.0 to 1.5 grams of tissue of the scaffold 200. In accordance with some embodiments of the invention, the each reservoir can be filled with approximately 0.5 million to 5 million cells/cc of solution. The seeding process continues until the desired amount of cells have perfused into the scaffold.

In accordance with some embodiments, the seeding process can be performed in a temperature controlled environment. In accordance with some embodiments of the invention, the temperature can remain substantially constant over the whole process. In accordance with some embodiments of the invention, the temperature can be changed over the course of the seeding process. In some embodiments, the seeding chamber can be maintained in a range from 20 to 40 degrees C.

In accordance with some embodiments of the invention, the seeded scaffold can be transferred to a perfusion bioreactor adapted to provide whole organ culture conditions. In accordance with some embodiments, instead of transferring the seeded scaffold, the environmental conditions inside the seeding chamber can be changed to conform to those determined for the bioreactor and the perfusion media can be input through the arterial connection while organ production from the ureter can monitored.

In accordance with other embodiments, the seeded scaffold can be implanted into a host human or non-human animal for in vivo culturing. In some embodiments, the kidney can be surgically implanted in the pelvis, and connected to the recipients inguinal artery, vein, and bladder. In other embodiments, the kidney can be surgically implanted in a subcutaneous position, and connected to the epigastric artery and vein, while the ureter conduit can be left to drain into the peritoneum until full maturation.

Evaluation of Regenerated Organ Function:

The function of regenerated or synthetic biofiltration organs or constructs as described herein can be evaluated and monitored by monitoring the composition of the filtrate.

As an example, for a regenerated kidney, the filtrate is urine, which will exit the kidney via the ureter (or, in the instance where a lung scaffold is re-populated with kidney epithelial cells, urine will accumulate and exit from the former airspace through the tracheal or bronchial tube). One of the normal functions of the kidney is to prevent loss of blood sugar, i.e., glucose to the urine. Thus, urine from a normal healthy individual should be very low in glucose. When a kidney scaffold is re-populated with endothelial and epithelial cells, the filtration function will generally take some time to become established, and the effluent from the ureter will initially comprise glucose from the perfusing medium. As the re-populated kidney begins to perform its filtration function, the filtrate produced will progressively be lower in glucose concentration, and the differential between the perfusing medium glucose and the urine/effluent glucose will be greater. In one embodiment, the regenerated kidney is sufficiently mature when the concentration of glucose in the urine is less than 50% that in the perfusing medium, and preferably less than 40%, less than 30%, less than 20%, less than 10%, less than 5% or lower relative to the concentration in the perfusing medium.

Another factor or metabolite normally retained by healthy kidney is creatinine clearance. As the re-populated kidney re-establishes biofiltration function, creatinine in the filtrate/urine will increase as more is cleared from the perfusate. Generally, clearance of at least 10% of perfusate creatinine is indicative of proper function, preferably at least 20%, 30%, 40%, 50%, 60%, 70%, 80% or more, up to the creatinine clearance rate of normal human kidney. Creatinine clearance rate drops with age in normal individuals. However, ranges are noted as follows. In men younger than 40 years, the normal rate is generally about 107-139 (mL/min) or 1.8-2.3 milliliters per second (mL/sec), and in women younger than 40 years, the normal rate is generally about 87-107 mL/min or 1.5-1.8 mL/sec. Creatinine clearance values normally go down as individuals age by about 6.5 mL/min for every 10 years past the age of 20.

Another measure of kidney maturity is retention of albumin. Normal urine is low in protein. Initially after re-population, albumin from the medium will be found in the effluent at relatively high concentration. As the kidney re-establishes its normal semipermeable barrier functions, the vasculature should become less permeable to proteins, including albumin, in the medium, and the urine concentration of albumin will decrease. In one embodiment, the regenerated kidney retains at least 30% of the albumin in the perfusate, preferably at least 40%, at least 50%, at least 60%, at least 70%, at least 80% or more. In one embodiment, the regenerated kidney retains at least 80% of the albumin in the perfusate. In one embodiment, the regenerated kidney retains at least 85% of the albumin in the perfusate. In one embodiment, the regenerated kidney retains at least 90% of the albumin in the perfusate. In one embodiment, the regenerated kidney retains 95% of the albumin in the perfusate. In one embodiment, the regenerated kidney retains at least 98% of the albumin in the perfusate. In one embodiment, the regenerated kidney retains at least 99% of the albumin in the perfusate. In one embodiment, the regenerated kidney retains 100% of the albumin in the perfusate.

In some embodiments, in vitro testing of kidney constructs allows for chemical analysis of urine samples and kidney function. For example, a urinalysis data can comprise the following data: Specific Gravity 1.003-1.040, pH4.6-8.0, Na 10-40 mEq/L, K Less than 8 mEq/L, Cl Less than 8 mEq/L, Protein 1-15 mg/dL, Osmolality80-1300 mOsm/L, Urine Bilirubin Negative, Urine Blood Negative, Urine Ketone Negative, Urine Leukocytes Negative, Urine Nitrite Negative, RBC's 0-2/HPF, WBC's 0-2/HPF. RBC Casts 0/HPF. Urobilogen 0.2-1.0 Ehr U/dl; 24 HOUR URINE VALUES: Amylase 250-1100 IU/24 hr, Calcium 100-250 mg/24 hr, Chloride 110-250 mEq/24 hr, Creatinine 1-2 g/24 hr, Creatine Clearance (Male) 100-140 mL/min, Creatine Clearance (Male) 16-26 mg/kg/24 hr. Creatine Clearance (Female) 80-130 mL/min. Creatine Clearance (Female) 10-20 mg/kg/24 hr, Magnesium 6-9 mEq/24 hr, Osmolality 450-900 mOsm/kg, Phosphorus 0.9-1.3 g/24 hr, Potassium 35-85 mEq/24 hr, Protein 0-150 mg/24 hr. Sodium 30-280 mEq/24 hr, Urea nitrogen 10-22 gm/24 hr. Uric acid 240-755 mg/24 hr).

Alternatively or in addition, the maturity of the regenerated kidney can be monitored or evaluated by inclusion of a tracer dye in the perfusing medium such as fluorescent labeled microspheres, and fluorescent labeled albumin. Retention of the dye in the perfusing medium is expected as the re-populated organ matures and establishes biofiltration function, with a decreasing proportion making its way into the filtrate/urine.

As an alternative to culture in a bioreactor such as one described herein after the scaffold is seeded, it is contemplated that, in certain embodiments, after permitting sufficient time for cellular attachment, the re-seeded organ can be transplanted directly to a recipient, without perfusion culture in a reactor. Under these circumstances, the recipient provides nutrients and natural growth factors, via their circulation, sufficient to maintain the transplant and permit or promote expansion and further differentiation of the seeded cells. Thus, while it is preferred that a re-populated, regenerated or artificially regenerated organ be as mature as possible, it is contemplated that the new organ need not be perfect to provide therapeutic benefit. Any therapy that, for example, extends the time between necessary renal dialysis treatments can have great impact on its recipients. As noted it is possible that implantation of a relatively immature organ will permit both immediately useful biofiltration and further maturation and improvement in function of the organ over time.

Transplantation:

Re-populated biofiltration organs as described herein can be transplanted to a recipient in need thereof. As noted herein, the recipient can be the same individual from whom re-populating cells are derived or, for example, the cells can be from a tissue matched donor. The transplanted organ generally need only have a connection to the circulatory system such that blood flows in the artery and out the vein. Filtrate can drain from transplanted organs to a catheter that exits the body, e.g., to a collecting bag, or, alternatively, the outflow from the organ, e.g., the ureter for a repopulated kidney or the former airspace or bronchioles for a repopulated lung can drain to a chosen system. Thus, in one embodiment, urine can be directed to drain to the urinary bladder, or bile can drain to the gallbladder.

The transplanted organ can be placed into its normal anatomic position, e.g., replacing a damaged or diseased organ at the site of that organ. Alternatively, it can be transplanted orthotopically to any site that provides the necessary arterial/venous supply and drainage and that permits sufficient space for the organ to exist.

### EXAMPLES

### Methods and Materials

### Perfusion Decellularization of Kidneys.

A total of 64 kidneys were isolated for perfusion decellularization. All animal experiments were performed in accordance with the Animal Welfare Act and approved by the institutional animal care and use committee at the Massachusetts General Hospital. We anesthetized male, 12-week-old, Sprague-Dawley rats (Charles River Labs, Wilmington, Mass.), using inhaled 5% isoflurane (Baxter, Deerfield, Ill.). After systemic heparinization (American Pharmaceutical Partners, Schaumburg, Ill.) through the infrahepatic inferior vena cava, a median laparotomy exposed the retroperitoneum. After removal of Gerota's fascia, perirenal fat, and kidney capsule, the renal artery, vein, and ureter were transected and a kidney was harvested from the abdomen. A 25-gauge cannula (Harvard Apparatus, Holliston, Mass.) was inserted into the ureter. Then, a prefilled 25-gauge cannula (Harvard Apparatus, Holliston, Mass.) inserted into the renal artery allowed antegrade arterial perfusion of heparinized PBS (Invitrogen, Grand Island, N.Y.) at 30 mmHg arterial pressure for 15-minutes to rid the kidney of residual blood. Decellularization solutions were then administered at 30 mmHg constant pressure in order: 12-hours of 1% SDS (Fisher, Waltham, Mass.) in deionized water, 15-minutes of deionized water, and 30-minutes of 1% Triton-X-100 (Sigma, St. Louis, Mo.) in deionized water. Following decellularization, PBS with 10,000 U/mL penicillin G, 10 mg/mL streptomycin, and 25 μg/mL amphotericin-B (Sigma, St. Louis, Mo.) washed the kidney at 1.5 mL/min constant arterial perfusion for 96-hours.

### Rat Neonatal Kidney Cell Isolation and Preparation

Day 2.5-3.0 Sprague-Dawley neonates were first euthanized in a CO₂ chamber and then decontaminated with 70% ethanol (Fisher, Waltham, Mass.). A median laparotomy allowed access to the kidneys, which were excised and stored on ice (4° C.) in Renal Epithelial Growth Media (REGM: Lonza, Atlanta, Ga.). Kidneys were then transferred to a 100 mm culture dish (Corning, Corning, N.Y.) for residual connective tissue removal and subsequent mincing into<1 mm³ pieces. The renal tissue slurry was resuspended in 1 mg/mL Collagenase I (Invitrogen, Grand Island, N.Y.) and 1 mg/mL Dispase (StemCell Technologies, Vancouver, BC, Canada) in DMEM (Invitrogen, Grand Island, N.Y.), and incubated in a 37° C. shaker for 30-minutes. The resulting digest slurry was strained (100 μm; Fisher, Waltham, Mass.) and washed with 4° C. REGM. We then resuspended non-strained tissue digested in collagenase/dispase as described above and repeated incubation, straining, and blocking. The resulting cell solutions were centrifuged (200 g, 5-minutes), and cell pellets were resuspended in 2.5 mL REGM, counted, and seeded into acellular kidney scaffolds as described below.

### Human Umbilical Vein Endothelial Cell Subculture and Preparation

M-cherry labeled human umbilical vein endothelial cells (gift, Joseph P. Vacanti) passages 8-10 were expanded on gelatin-a (BD Biosciences, Bedford, Mass.) coated cell culture plastic and grown with Endothelial Growth Medium-2 (EGM2: Lonza, Atlanta, Ga.). At the time of seeding, cells were trypsinized, centrifuged, resuspended in 2.0 mL of EGM2, counted, and subsequently seeded into decellularized kidneys as described below.

### Cell Seeding

Trypsinized, 50.67±12.84×10⁶ human umbilical vein endothelial cells (HUVEC) diluted in 2.0 mL EGM-2 were seeded into the acellular kidney scaffold via the arterial cannula at 1.0 mL/min constant flow (n=26). Cells were allowed to attach overnight after which perfusion culture resumed. 60.71±11.67×10⁶ rat neonatal kidney cells were isolated following the procedure described above, counted, and resuspended in 2.5 mL of REGM. The cell suspension was seeded through the ureter cannula after subjugating the organ chamber to a −40 cm H₂O pressure (n=26). Cells were allowed to attach overnight after which perfusion culture resumed.

### Bioreactor Design and Whole Organ Culture

The kidney bioreactor was designed as a closed system that could be gas sterilized after cleaning and assembly, needing only to be opened once at the time of organ placement. Perfusion media and cell suspensions could be infused through sterile access ports (Cole-Parmer, Vernon Hills, Ill.) to minimize the risk of contamination. The decellularized kidney matrix was connected to a perfusion system through the renal artery, vein, and ureter, and was placed in a sterile, water-jacketed organ chamber (Harvard Apparatus, Holliston, Mass.). After flowing through a silicone tube oxygenator (Cole-Parmer, Vernon Hills, Ill.) equilibrated with 5% CO₂ 95% room-air, oxygenated media perfused the renal artery at 1.5 mL/min. The ureter and vein were allowed to drain passively through separate compartments into the reservoir during biomimetic culture.

### Isolated Kidney Experiments

To assess in vitro kidney function, single native, regenerated, and decellularized kidneys were perfused with 0.22 μm-filtered (Fisher, Waltham, Mass.) Krebs-Henseleit (KH) solution containing: NaHCO₃ (25.0 mM), NaCl (118 mM), KCl (4.7 mM), MgSO₄ (1.2 mM), NaH₂PO₄ (1.2 mM), CaCl₂ (1.2 mM), BSA (5.0 g/dL), D-glucose (100 mg/dL), urea (12 mg/dL), creatinine (20 mg/dL), (Sigma Aldrich, St. Louis, Mo.). Amino acids glycine (750 mg/L), L-alanine (890 mg/L), L-asparagine (1,320 mg/L), L-aspartic acid (1330 mg/L), L-glutamic acid (1470 mg/L), L-proline (1150 mg/L), and L-serine (1050 mg/L) were added prior to testing (Invitrogen, Grand Island, N.Y.). KH solution was oxygenated (5% CO₂, 95% O₂), warmed (37° C.), and perfused through the arterial cannula at 80-120 mmHg constant pressure without recirculation. Urine and venous effluent passively drained into separate collection tubes. Samples were taken at 10, 20, 30, 40, and 50-minutes after initiating perfusion, and immediately frozen at −80° C. until analyzed. Urine, venous effluent, and perfusing KH solutions were quantified using a Catalyst Dx Chemistry Analyzer (Idexx, Westbrook, Me.). The reval vascular resistance (RVR) was calculated as arterial pressure (mmHg)/renal blood flow (ml/g/min). After completion of in vitro experiments, kidneys were flushed with sterile PBS, decannulated, and transferred to a sterile container in cold (4° C.) PBS until further processing.

### Histology, Immunofluorescence, and Immunohistochemistry

Native, decellularized, and regenerated kidneys were processed following the identical fixation protocol for paraffin embedding (5% formalin buffered PBS, Fisher, Waltham, Mass.) for 24-hours at room temperature while sections deemed for frozen sections were fixed overnight in 4% paraformaldehyde (Fisher, Waltham, Mass.) at 4° C. Sections were embedded in paraffin or Tissue Tek OCT compound (VWR, Bridgeport, N.J.) for sectioning following standard protocols. Tissue sections were cut into 5 μm sections and H&E staining was performed (Sigma Aldrich, St. Louis, Mo.) using standard protocols. Sections were also stained with Movat's Pentachrome (American Mastertech, Lodi, Calif.) following the manufacturer protocol.

Paraffin embedded sections underwent deparaffinization with 2 changes of xylene (5-minutes), 2 changes of 100% ethanol (3-minutes), 2 changes of 95% ethanol (3-minutes), and placed in deionized water (solutions all from Fisher, Waltham, Mass.). For immunostaining, deparaffinized slides first underwent antigen retrieval in heated (95° C.) Sodium Citrate Buffer Solution, pH=6.0 (Dako, Carpinteria, Calif.) for 20-minutes, then allowed to cool to room temperature for 20-minutes. For immunostaining of collagen IV, elastin, and laminin epitopes, slides were blocked for 5-minutes in PBS, and then incubated with 20 μg/mL Proteinase-K (Sigma, St. Louis, Mo.) in TE buffer, pH=8.0 at 37° C. for 10-minutes. Following a 5-minute block in PBS, slides received Dual Endogenous Enzyme-Blocking Reagent (Dako, Carpinteria, Calif.) for 5-minutes, then blocking buffer (1% BSA, 0.1% Triton-X in PBS: Sigma, St. Louis, Mo.) for 30-minutes. Primary antibodies were allowed to attach overnight at 4° C. Primary antibody dilutions were made with blocking buffer and were as follows: 1:50 anti-elastin, 1:50 anti-laminin (Santa Cruz Biotech, Santa Cruz, Calif.); 1:50 anti-collagen IV (Lifespan Bioscience, Seattle, Wash.); 1:200 anti-podocin, 1:200 anti-Na/K-ATPase (Abcam, Cambridge, Mass.); and 1:200 anti-E-Cadherin (R&D Systems, Minneapolis, Minn.). After primary antibody incubation, slides were washed in PBS for 5-minutes, and a secondary antibody conjugated to HRP was added at 1:100 for 30-minutes (Dako, Carpinteria, Calif.). The resulting slides were PBS washed and developed with 3,3′-diaminobenzidine (Dako, Carpinteria, Calif.) until good staining intensity was observed. Nuclei were counterstained with hematoxylin (Sigma, St. Louis, Mo.). A coverslip was mounted using permount (Fisher, Waltham, Mass.) after dehydration with a sequential alcohol gradient and xylene (Fisher, Waltham, Mass.).

For immunofluorescence, paraffin embedded sections underwent deparaffinization, antigen retrieval, and received primary antibodies dilutions prepared in blocking buffer as described above. After primary antibody addition, slides were blocked as described above. Fluorescent secondary antibodies all 1:250 diluted in blocking buffer (anti-species conjugated to Alexa-fluorophores: Invitrogen, Grand Island, N.Y.) were allowed to attach for 45-minutes. Nuclei were counterstained with DAPI (Invitrogen, Grand Island, N.Y.) and coverslip (Fisher, Waltham, Mass.) mounted using Fluoromount-G (Southern-Biotech, Birmingham, Ala.). Omission of primary antibody and species immunoglobulin G1 antibody (Vector Labs, Burlingame, Calif.) served as negative controls for both immunohistochemistry and immunofluorescence. Immunohistochemistry, H&E, and pentachrome stained images were recorded using a Nikon Eclipse TE200 microscope (Nikon, Tokyo, Japan) while immunofluorescent images were recorded using a Nikon AlR-A1 confocal microscope (Nikon, Tokyo, Japan).

### Transmission Electron Microscopy

Tissues were fixed in 2.0% glutaraldehyde in 0.1 M sodium cacodylate buffer, pH 7.4 overnight at 4° C., rinsed, post-fixed in 1.0% osmium tetroxide in cacodylate buffer for one hour at room temperature, and rinsed (Electron Microscopy Sciences, Hatfield, Pa.). Then, sections were dehydrated through a graded series of ethanol and infiltrated with Epon resin (Ted Pella, Redding, Calif.) in a 1:1 solution of Epon:ethanol overnight. Sections were then placed in fresh Epon for several hours and then embedded in Epon overnight at 60° C. Thin sections were cut on a UC6 ultramicrotome (Leica, Buffalo Grove, Ill.), collected on formvar-coated grids, stained with uranyl acetate and lead citrate and examined in a JEM 1011 transmission electron microscope at 80 kV (Jeol, Peabody, Mass.). Images were collected using an AMT digital imaging system (Advanced Microscopy Techniques, Danvers, Mass.).

SDS, DNA, Collagen, and sGAG Quantification

SDS was quantified using Stains-All Dye (Sigma, St. Louis, Mo.) as previously described³⁰. Briefly, lyophilized tissues were digested in collagenase buffer (Sigma, St. Louis, Mo.) for 48 hrs at 37° C., with gentle rotation. Digests supernatants (1 μL) containing any residual SDS were then added to 4 ml of a working Stains-All Dye solution and then absorbance was measured at 488 mm. DNA was quantified using the Quanti-iT PicoGreen dsDNA kit (Invitrogen, Grand Island, N.Y.). Briefly, DNA was extracted from lyophilized tissue samples in Tris-HCl buffer with Proteinase-K (200 ug/ml) (Sigma, St. Louis, Mo.) for 3 hrs at 37° C., with gentle rotation. Digest supernatants (10 μL) were diluted in TE buffer and then mixed with prepared PicoGreen reagent. Samples were excited at 480 nm and fluorescence measured at 520 nm. Soluble collagen was quantified using the Sircol Assay (Biocolor), as per manufacturer's instructions. Lyophilized tissue samples were first subjected to acid-pepsin collagen extraction overnight at 4° C., followed by overnight isolation and concentration. Assay was then performed as instructed. Sulfated Glycosaminoglycans were quantified using the Blyscan Assay (Biocolor). Prior to measurement, sGAG were extracted using a papain extraction reagent (Sigma, St. Louis, Mo.) and heated for 3 hrs at 65° C. Assay was then performed as instructed. All concentrations were determined based on a standard curve generated in parallel, and values were normalized to original tissue dry weight.

### Chemical Analysis of Blood and Urine Samples

Blood and urine chemistries were analyzed using a Catalyst Dx® Chemistry Analyzer (IDEXX Laboratories, Westbrook, Me., USA), integrated with a IDEXX VetLab® Station for comprehensive sample and data management. As per the manufacturer's protocol, 700 μL were analyzed for each blood sample, and 300 μL were analyzed for each urine sample. When necessary, urine samples were diluted based on the urine volume collected and adding diluent for a sample volume of 300 μL, and results account for dilution calculations. Blood samples were first passed through a lithium heparin whole blood separator before being analyzed, and no dilutions were needed for these samples. All samples were passed through proprietary IDEXX diagnostic CLIPs Chem 10 (ALB, ALB/GLOB, ALKP, ALT, BUN, BUN/CREA, CREA, GLOB, GLU, TP) and Lyte 4 (Cl, K, Na, Na/K), as well as single diagnostic slides for magnesium, calcium, and phosphate.

### Morphometric Quantification of Glomeruli

Ten low-powered fields (4×) were randomly selected from the subcapsular and juxtamedullary regions of H&E stained sections (5 μm) of native, decellularized, and regenerated kidneys (n=3 in each group). Glomeruli were counted in each of the 10 fields to determine the average number of glomeruli per section, and the numbers of glomeruli/section in experiments from the same group were used to determine the mean glomeruli in each type of kidney (mean±SEM). Re-seeded glomeruli in regenerated kidneys were counted as a sub-set in each of the 10 low-powered fields, and then averaged per experiment. The percentage of re-seeded glomeruli for each experiment was calculated using the average number of re-seeded glomeruli versus the average number of glomeruli/section, and used to calculate the mean percentage of re-seeded glomeruli in regenerated kidneys (mean %±SEM). Ten high-powered fields (20×) of individual glomeruli from the same H&E sections of native, decellularized, and regenerated kidneys were used for morphometric analysis (n=3 in each group). All morphometric measurements were determined using Image J (NIH). For each of the individual glomeruli, both the long and short axes diameters of the renal corpuscle were measured. Bowman's space was determined subtracting the area measured around the inner surface of the Bowman's capsule from the area measured around the outer surface of the glomerular capillary bed. All measurements were averaged per experiment, and experiments from the same group were used to determine mean values±SEM.

### Organ Preparation and Orthotopic Transplantation

Native, decellularized or regenerated kidneys were treated identically with exception that native kidneys were harvested from anesthesized (5% inhaled isoflurane), 12-week-old, male Sprague-Dawley rats after systemic heparinization. Native kidneys were exposed and harvested identically as described above for perfusion decellularization with exception that the left renal artery was flushed with 4° C. Belzer UW Cold Storage Solution (Bridge to Life, Columbia, S.C.) at 1 mL/min for 5 minutes prior to surgical manipulation of the kidney, and rinsed with 20 mL sterile 4° C. PBS prior to implantation.

Kidney grafts were prepared for orthotopic transplantation by dissecting the hilar structures (artery, vein, and ureter) circumferentially on ice. The graft renal artery and vein was cuffed using a modified cuff technique described previously¹⁷ with a 24G and 20G, respectively, FEP polymer custom-made cuff (Smith-Medical, Dublin, Ohio). For in vivo experiments, 10-week old (220-225 grams) NIHRNU-M recipient rats (Taconic Farms, Germantown, N.Y.) underwent 5% inhaled isoflurane induction and were maintained with ventilated 1-3% inhaled isoflurane via a 16G endotracheal tube (BD Biosciences, Bedford, Mass.). Animals were placed supine on a heating pad (Sunbeam, Salem, Mass.). After a median laparotomy and systemic heparinization through the right renal vein, left recipient renal artery, vein, and ureter were identified, dissected circumferentially, and incised close to the left hilum sparing the left suprarenal artery. The left renal artery and vein were then clamped using a micro serrefines clamp (Fine Science Tools, Foster City, Calif.). The left kidney was then carefully separated from Gerota's fascia and removed. The regenerated kidney graft artery and venous cuffs were inserted into the recipient's vessels and secured with a 6-0 silk ligation (Fine Science Tools, Foster City, Calif.). The recipient artery and vein were then unclamped and patent anastomoses were confirmed. Urine was allowed to drain passively from the ureter, through a 25G angiocath (Harvard Apparatus, Holliston, Mass.). Cadaveric orthotopic kidney transplants, and decellularized kidney transplants serves as controls.

### Example 1

### Perfusion Decellularization of Cadaveric Kidneys

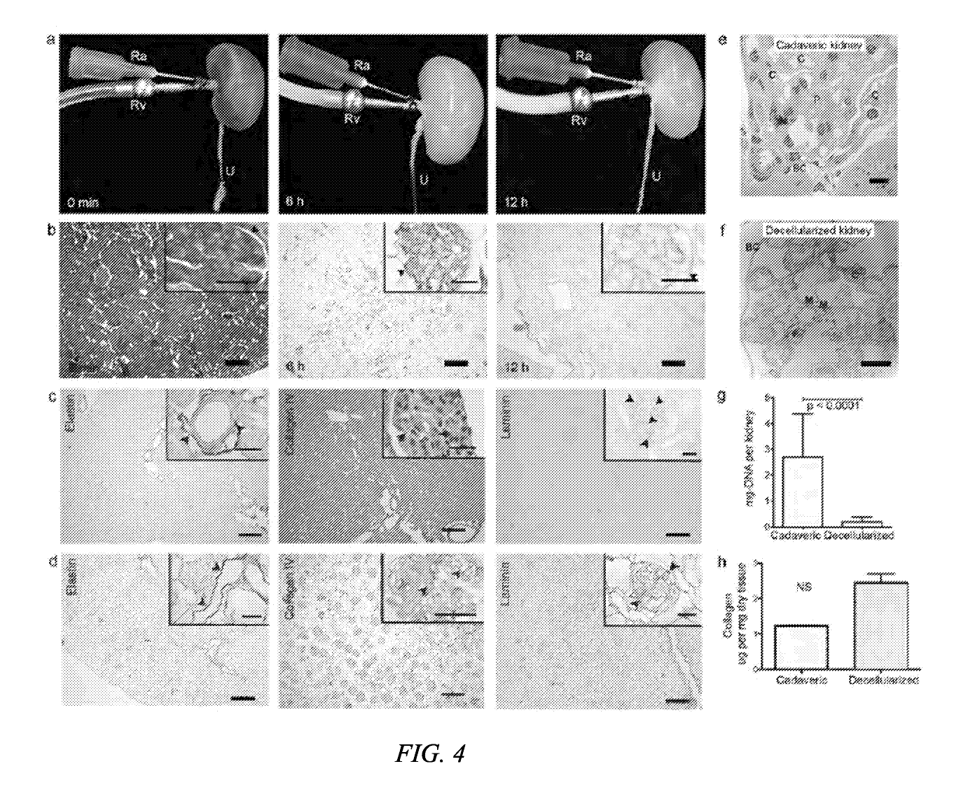

Cadaveric rat kidneys were decellularized via renal artery perfusion with 1% sodium dodecyl sulfate (SDS) at a constant pressure of 40 mmHg (FIG. 4a, time-lapse). Histology of acellular kidneys showed preservation of tissue architecture and the complete removal of nuclei and cellular components (FIG. 4b, time-lapse). Perfusion decellularization preserved the structure and composition of renal ECM integral in filtration (glomerular basement membrane), secretion, and reabsorption (tubular basement membrane). As seen with other tissues, the arterial elastic fiber network remained preserved in acellular cortical and medullary parenchyma.

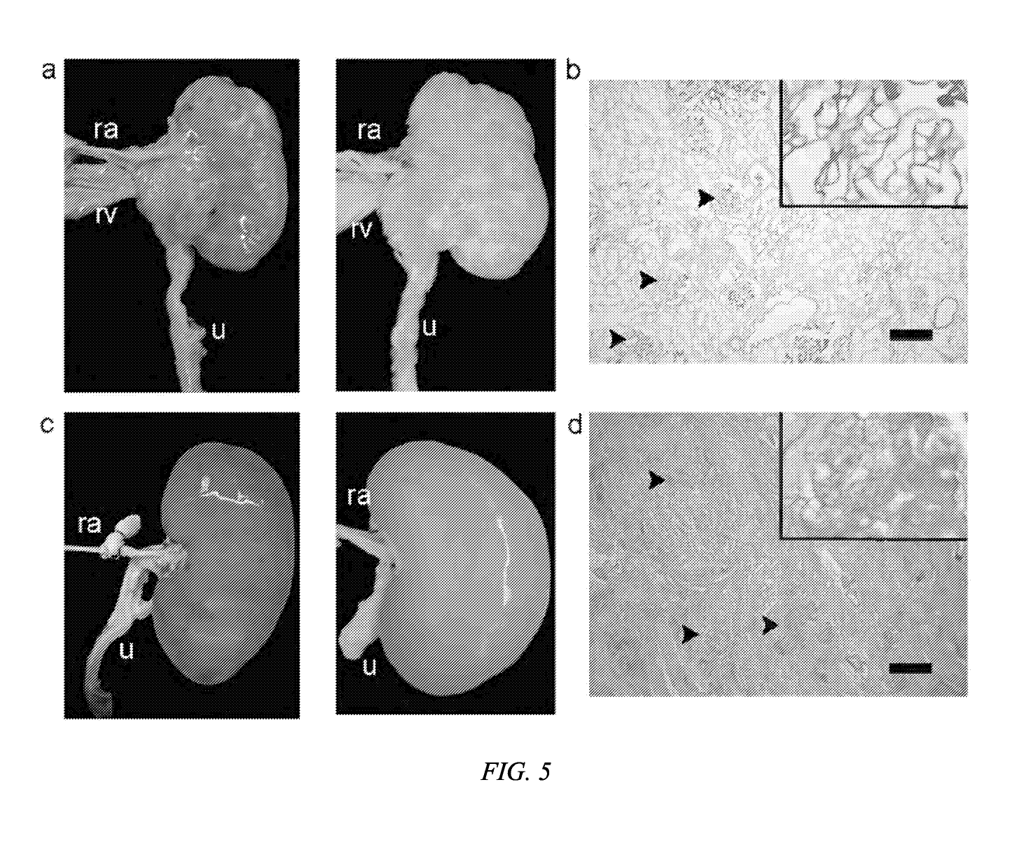

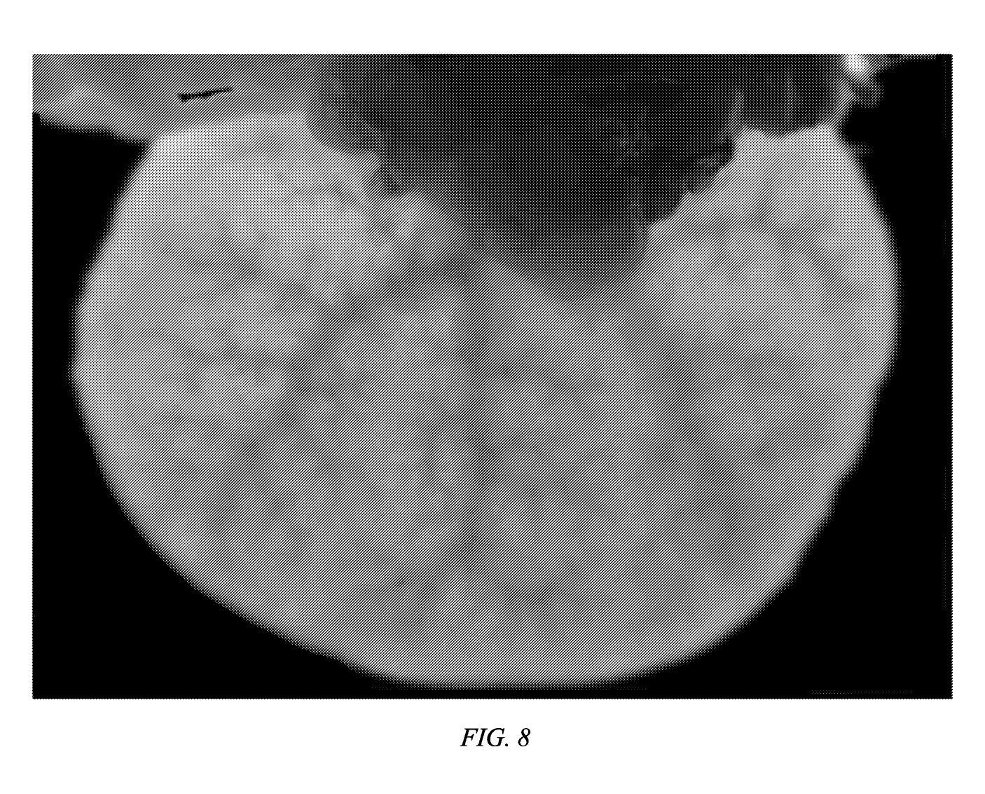

Immunohiostochemical staining confirmed presence of key ECM components such as Laminin and Collagen IV in physiologic distribution such as the acellular glomerular basement membrane (FIGS. 4c,d). The microarchitecture of the lobulated glomerular basement membrane with capillary and mesangial matrix extending from the centrilobular stalk remained intact. Acellular glomeruli were further encompassed by a multilayered corrugated and continuous Bowman's capsule basement membrane (FIGS. 4e,f). Tubular basement membranes remained preserved with dentate evaginations extending into the proximal tubular lumen. Upon high magnification scanning electron microscopy, parallel cristae of the luminal surface of proximal tubules juxtaposed the less parallel meshwork in distal tubule luminal surfaces consistent with previously reported electron microscopic assessment of acellular renal tissues (Atala, A., Bauer, S. B., Soker, S., Yoo, J. J. & Retik, A. B. Tissue-engineered autologous bladders for patients needing cystoplasty. Lancet 367, 1241-1246 (2006) (not shown). SDS, deionized water, and Triton-X 100 reduced the total DNA content per kidney to less than 10% (FIG. 4g). After PBS washing, SDS was undetectable in acellular kidney scaffolds. Concentrations of ECM total collagen and glycosaminoglycans were preserved at levels not significantly different from cadaveric kidney tissue (FIG. 4h,i). To confirm scalability of the perfusion decellularization protocol to large animal and human kidneys, we successfully decellularized porcine and human kidneys using a similar perfusion protocol (FIG. 5. illustrates the perfusion decellularization of large animal and human kidneys. Photograph of cadaveric (left) and decellularized (middle panels) human sized kidneys suggesting perfusion decellularization of rat kidneys may be upscaled to generate acellular kidney ECMs for direct clinical translation. Ra, renal artery; Ur, Ureter. Corresponding Pentachrome staining for decellularized pig and human kidneys (right panels). Scale bar, 250 um). Preservation of perfusable channels along a hierarchical vascular bed was confirmed by dye perfusion similar to our prior experience with perfusion decellularized hearts and lungs (FIG. 8). Functional testing of acellular kidney scaffolds by perfusion of the vasculature with modified Krebs-Henseleit solution under physiologic perfusion pressure resulted in production of a filtrate with nearly equal amounts of protein, glucose and electrolytes as the perfusate suggesting hydrostatic filtration across glomerular and tubular basement membranes with loss of macromolecular sieving and active reabsorption (described in further detail below).

### Example 2

### Morphometry of Acellular Kidney Matrices

To assess the microarchitecture of acellular kidney scaffolds, we applied an established histology-based morphometry protocol to quantify the average number of glomeruli, glomerular diameter, glomerular capillary lumen, and partial Bowman's space (Olivetti, G., Anversa, P., Rigamonti, W., Vitali-Mazza, L. & Loud, A. V. Morphometry of the renal corpuscle during normal postnatal growth and compensatory hypertrophy. A light microscope study. J Cell Biol 75, 573-585 (1977)). Perfusion decellularized kidneys shrank most with fixation, dehydration and embedding compared to cadaveric kidneys (FIG. 5j). The apparent number of glomeruli per mm² of renal cortex therefore increased with decellularization, but remained constant when normalized to total cross sectional area. Correspondingly, the total glomerular count per coronal cross section through the hilum remained constant with decellularization. Glomerular diameter, Bowman's space and glomerular capillary surface area did not differ between cadaveric and decellularized kidneys.

### Example 3

### Recellularization of Acellular Kidney Matrices

To regenerate perfusable, functional kidney tissue we attempted to repopulate acellular rat kidneys with endothelial and epithelial cells. Cell seeding was accomplished by perfusion of suspended human umbilical venous endothelial cells (HUVEC) via the renal artery and instillation of suspended rat neonatal kidney cells (NKC) via the ureter. Cell delivery and retention was drastically improved when kidney scaffolds were mounted in a seeding chamber that allowed the application of a vacuum to generate a pressure gradient across the scaffold (FIG. 5a). Attempts to seed NKCs applying positive pressure to the collecting system did not reach the glomerulus, while cell seeding using a transrenal gradient allowed for cell dispersion throughout the entire kidney parenchyma. When the ambient vacuum during cell seeding was increased to greater than 70 cm H₂O, tissue damage in calyxes and parenchyma, and in extreme cases, tissue disruption was observed. A vacuum of 40 cm H₂O lead to no macroscopic or microscopic tissue damage or leakage of cells, which is consistent with data on isolated tubular basement membrane mechanical properties (Welling, L. W. & Grantham, J. J. Physical properties of isolated perfused renal tubules and tubular basement membranes. J Clin Invest 51, 1063-1075 (1972)). After seeding, kidney constructs were transferred to a perfusion bioreactor designed to provide whole organ culture conditions (FIG. 5b,c). Human umbilical vein endothelial cells (HUVECs) were found to engraft on acellular kidney matrices similar to prior experiments with lung and heart scaffolds. After three to five days of perfused organ culture, we observed vascular channels lined with endothelial cells extending throughout the entire scaffold cross section, from segmental, interlobar, and arcuate arteries to glomerular and peritubular capillaries (FIG. 5d). Because a variety of epithelial cell phenotypes in different niches along the nephron contribute to urine production, we elected to reseed a combination of rat NKCs (postnatal day 2-3) via the ureter in addition to HUVECs via the renal artery. Freshly isolated, enzymatic digests of day 2-3 rat neonatal kidneys produced single-cell suspensions of NKCs consisting of a heterogeneous mixture of all kidney cell types including epithelial, endothelial, and interstitial lineages. When cultured on cell culture plastic for 12 hours after isolation, 8% of adherent cells stained positive for podocin indicating a glomerular epithelial phenotype, 69% stained positive for Na/K-ATPase indicating a proximal tubular phenotype, and 25% stained positive for E-Cadherin indicating a distal tubular phenotype (data not shown). After cell seeding, kidney constructs were mounted in a perfusion bioreactor and cultured in whole organ biomimetic culture (n=31). An initial period of static culture enabled cell attachment, after which perfusion was initiated to provide oxygenation, nutrient supply and a filtration stimulus. Neonatal rats are unable to excrete concentrated urine due to immaturity of the tubular apparatus (Falk, G. Maturation of renal function in infant rats. Am J Physiol 181, 157-170 (1955)). To facilitate in vitro nephrogenesis and maturation of NKCs in acellular kidney matrices, we supplemented the culture media with known in vivo maturation signals such as glucocorticoids and catecholamines to accelerate the development of urine-concentrating properties. We cultured the reseeded kidneys under physiologic conditions for up to twelve days. On histologic evaluation after as early as four days in culture, we observed repopulation of the renal scaffold with epithelial and endothelial cells with preservation of glomerular, tubular, and vascular architecture. NKCs and HUVECs engrafted in their appropriate epithelial and vascular compartments (FIG. 5e). The spatial relationship of regenerated epithelium and endothelium resembled the microanatomy and polarity of the native nephron providing the anatomic basis for water and solute filtration, secretion, and reabsorption. Immunostaining revealed densely seeded glomeruli with endothelial cells and podocytes. Across the entire kidney, podocytes appeared to be preferentially engrafted in glomerular regions, although occasional non site-specific engraftment was observed (FIG. 5f-h). Epithelial cells engrafted on glomerular basement membranes stained positive for beta-1 integrin suggesting potential site-specific cell adhesion to ECM domains, and providing a mechanistic explanation for the observed site-specific cell engraftment (FIG. 5i). Engrafted epithelial cells were found to reestablish polarity and organize in tubular structures expressing Na/K-ATPase and aquaporin similar to native proximal tubular epithelium. Similarly, epithelial cells expressing e-cadherin formed structures resembling native distal tubular epithelium and collecting ducts (FIG. 5e,j-l). E-cadherin positive epithelial cells lined the renal pelvis similar to native transitional epithelium. Transmission and scanning electron microscopy of regenerated kidneys showed perfused glomerular capillaries with engrafted podocytes and formation of foot processes (FIG. 5m, n). Morphometric analysis of regenerated kidneys showed recellularization of more than half of glomerular matrices, resulting in an average number of cellular glomeruli per regenerated kidney of approximately 70% of that of cadaveric kidneys. Average glomerular diameter, Bowman's space and glomerular capillary lumen appeared to be smaller in regenerated kidneys compared to cadaveric kidneys (FIG. 5o).

### Example 4

### In Vitro Function of Acellular and Regenerated Kidneys

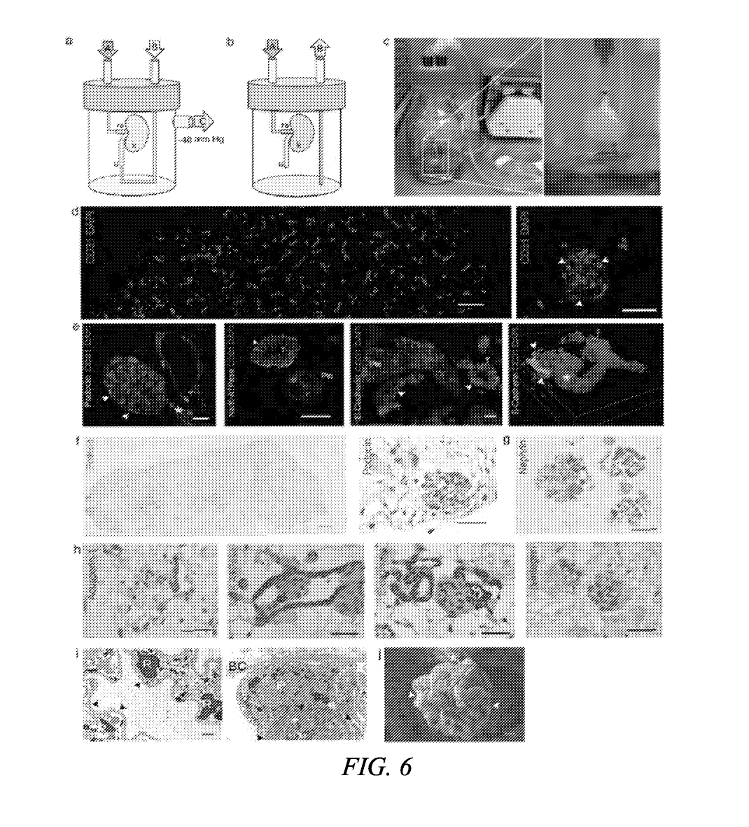

After cell seeding and whole organ culture, we tested the in vitro capacity of regenerated kidneys to filter a standardized perfusate, to clear metabolites, to reabsorb electrolytes and glucose, and to generate concentrated urine (FIG. 6a). Cadaveric, decellularized, and regenerated kidneys were perfused at physiologic pressures via the renal artery with a Krebs-Henseleit (KH) bicarbonate buffered solution containing albumin, urea, and electrolytes. Urine samples were analyzed and compared amongst the three groups. Decellularized kidneys produced nearly twice as much filtrate as cadaveric controls; regenerated kidneys produced the least amount of urine. All three groups maintained a steady urine output over the testing period (FIG. 6b,c). Based on the results of urinalysis we calculated creatinine clearance as an estimate for glomerular filtration rate, and fractional solute excretion as a measure of tubular absorptive and secretory function (FIG. 6d). Due to increased dilute urine production, calculated creatinine clearance was increased in decellularized kidneys when compared to cadaveric kidneys indicating increased glomerular (and likely additional tubular and ductal) filtration across acellular basement membranes. After repopulation with endothelial and epithelial cells, creatinine clearance of regenerated constructs reached approximately 10% of cadaveric kidneys, which indicates a decrease of glomerular filtration across a partially reconstituted and likely immature glomerular membrane (FIG. 6c). Vascular resistance was found to increase with decellularization, and decrease after re-endothelialization, but remained higher in regenerated constructs compared to cadaveric kidneys (FIG. 6e). This finding in line with our prior observations in cardiac and pulmonary re-endothelialization and may be related to relative immaturity of the vascular bed and micro-emboli from cell culture media. When in vitro renal arterial perfusion pressure was increased to 120 mmHg, urine production and creatinine clearance in regenerated kidneys reached up to 23% of cadaveric kidneys (FIG. 6b,c). Albumin retention was decreased in decellularized kidneys to a level consistent with the estimated contribution of the denuded glomerular basement membrane to macromolecular sieving. With recellularizaton, albumin retention was partially restored leading to improved, but persistent albuminuria in regenerated kidneys. Glucose reabsorption was lost with decellularization, consistent with free filtration and the loss of tubular epithelium. Regenerated kidneys showed partially restored glucose reabsorption, suggesting engraftment of proximal tubular epithelial cells with functional membrane transporters resulting in decreased glucosuria. Higher perfusion pressure did not lead to increased albumin or glucose loss in regenerated kidneys. Selective electrolyte reabsorption was lost in decellularized kidneys. Slightly more creatinine than electrolytes were filtered, leading to an effective fractional electrolyte retention ranging from 5-10%. This difference may be attributed to the electrical charge of the retained ions and the basement membrane (Bray, J. & Robinson, G. B. Influence of charge on filtration across renal basement membrane films in vitro. Kidney Int 25, 527-533 (1984)), while the range amongst ions may be related to subtle differences in diffusion dynamics across acellular vascular, glomerular and tubular basement membranes. In regenerated kidneys, electrolyte reabsorption was restored to approximately 50% of physiologic levels, which further indicates engraftment and function of proximal and distal tubular epithelial cells. Fractional urea excretion was increased in decellularized kidneys, and returned to a more physiologic range in regenerated kidneys, which suggests partial reconstitution of functional collecting duct epithelium with urea transporters.

### Example 5

### Orthotopic Transplantation and In Vivo Function of Regenerated Kidneys

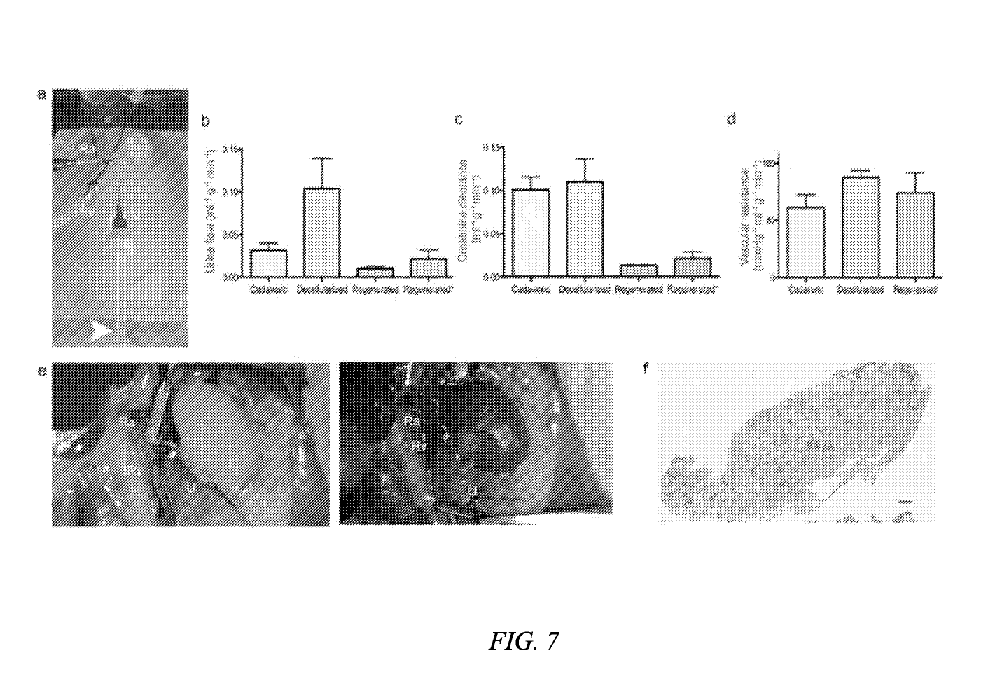

Because regenerated kidneys produced urine in vitro, we hypothesized that bioartificial kidneys could function in vivo after orthotopic transplantation. We performed experimental left nephrectomies and transplanted regenerated left kidneys in orthotopic position. We anastomosed regenerated left kidneys to the recipient's renal artery and vein (FIG. 7a). Throughout the entire test period, regenerated kidney grafts appeared well perfused without any evidence of bleeding from vasculature, collecting system or parenchyma (FIG. 7b). The ureter remained cannulated to document in vivo production of clear urine without evidence of gross hematuria and to collect urine samples. Regenerated kidneys produced urine from shortly after unclamping of recipient vasculature until planned termination of the experiment. Histological evaluation of explanted regenerated kidneys showed blood-perfused vasculature without evidence of parenchymal bleeding or microvascular thrombus formation (FIG. 7c,d).

Corresponding to in vitro studies, decellularized kidneys produced a filtrate which was high in glucose (249±62.9 mg/dL vs. 29±8.5 mg/dL in native controls) and albumin (26.85±4.03 g/dL vs. 0.6±0.4 g/dL in native controls), while low in urea (18±42.2 mg/dL vs. 617.3±34.8 mg/dL in native controls), and creatinine (0.5±0.3 mg/dL vs. 24.6±5.8 mg/dL in native controls).

Regenerated kidneys produced less urine than native kidneys (1.2±0.1 μl/min vs. 3.2±0.9 μl/min in native controls, 4.9±1.4 μl/min in decellularized kidneys) with lower creatinine (1.3±0.2 mg/dL) and urea (28.3±8.5 mg/dL) than native controls, but showed improved glucosuria (160±20 mg/dL) and albuminuria (4.67±2.51 g/L) when compared to decellularized kidneys. Similar to the in vitro results, creatinine clearance in regenerated kidneys was lower than that of native kidneys (0.01±0.002 ml/min vs. 0.36±0.09 ml/min in native controls) as was urea excretion (0.003±0.001 mg/min vs. 0.19±0.01 mg/min in native controls). Orthotopic transplantation of regenerated kidneys showed immediate graft function during blood perfusion via the recipient's vasculature in vivo without signs of clot formation or bleeding. Results of urinalysis corresponded to the in vitro observation of relative immaturity of the constructs.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

1. A cell seeding system for seeding a filtration organ scaffold, the filtration organ including at least one arterial vessel and at least one efferent vessel, the system comprising:
a sealed seeding chamber adapted to enclose a bioartificial filtration organ scaffold for cell seeding and to provide a pressure controlled environment inside the seeding chamber, the seeding chamber including a plurality of ports adapted to allow a first fluid channel to pass a cell suspension fluid into the seeding chamber and to allow at least one air pressure channel to connect the inside of the seeding chamber with air pressure pump;
a pressure sensor adapted to sense the environmental pressure inside the seeding chamber; and

2-29. (canceled)
